(19) United States
(12) Patent Application Publication
(10) Pub. No.: US 2008/0191375 A1
(43) Pub. Date: Aug. 14, 2008

(54) Manufacturing Method For A Composite Structure

(76) Inventor: Yong Goo Lee, Kyounggi-do (KR)

Correspondence Address: IPLA P.A., 3580 WILSHIRE BLVD., 17TH FLOOR, LOS ANGELES, CA, 90010, US

(21) Appl. No.: 11/814,451

(22) PCT Filed: Jan. 19, 2006
(86) PCT No.: PCT/KR2006/000211

§ 371 Date: Jul. 20, 2007

(30) Foreign Application Priority Data
Jan. 20, 2005 (KR) 10-2005-0005359

(51) Int. Cl. B28B 5/00

(52) U.S. Cl. 264/101

(57) ABSTRACT

This invention relates to a method for manufacturing a composite structure to be used in architectural, civil and mechanical fields, by adopting a hardening process for filler (A) and fluid hardener (B) in a mould, where mechanical and physical properties are improved when the particle state of filler (A), the primary material, and the 1fluid state of hardener (B), the subsidiary material, are combined densely, without pores, in the mould (10) in a vacuum state maintained for the required time, and due to excellent workability secured in the process, various kinds of composite structures can be manufactured with ease in a large scale of production and at a lower costs.

### TECHNICAL FIELD

This invention relates to a method of manufacturing a composite structure for application to facilities for fields such as architectural, civil and mechanical, especially in a state where fillers, a primary material, made of solid particles, and a subsidiary material, comprising fluid hardeners, are evenly mixed and processed to form a composite structure of composed of fillers and hardeners that are firmly bonded.

### BACKGROUND ART

As noted generally, developments of a composite structure with improved physical and chemical characteristics that can be applied to various areas comprising such fields as civil, architectural and mechanical are increasingly needed.

Originating from the growing requirement of a composite that is formed of a mixture of solid fillers and fluid hardeners by compounding materials appropriately, this method of forming a composite structure is most widely used owing to its advantage of easiness in manufacturing composites with various characteristics just through variation of fillers, sizes of particles, kinds of hardeners and mixing ratio of solid fillers and fluid hardeners.

In case fillers, the subsidiary material of solid particles, are added to the primary material, of hardeners various types and shapes of composite structures can be manufactured with ease due to good fluidity from evenly mixed fillers and hardeners, while the mixture made by adding subsidiary material of the fluid hardener into primary material of the fillers can not be used for manufacturing various types and shapes of composite structure due to poor fluidity of the mixtures.

As a composition ratio of hardener gets lower, moulding workability decreases due to high viscosity and low fluidity of a mixture, while mechanical and physical properties of a composite is greatly improved as raw material of fillers in the solid state are correspondingly increased.

Accordingly, conventional method of manufacturing was to separate a composite structure from the mould after the hardener was naturally hardened after putting the well mixed compound of fillers i.e., the primary material comprising the solid particles, and the subsidiary material i.e., the fluid hardener, into the stirrer for mixing evenly by addition of an external force.

However, this conventional method of manufacturing has the following disadvantages, such as: a serious problem of restriction on the shape of a composite structure owing to inability to charge the mixture into a mould securely in a case that the ratio of solid particles is high; its complexity of production process originating from inefficiencies such as necessity of additional stirring facility to evenly mix the solid fillers and the fluid hardener (considerable amount of force is needed to mix fillers and the hardener), and a need of an inordinate degree of external force to charge the mixture of the low viscosity and fluidity into the mould and need to stabilize the mixture by vibrating the mould.

Furthermore, under existing method, a mixture can not be free from fine pores caused by forced mixing of fillers and a hardener, in the process, by a stirrer, while the hardening process goes on without releasing the porosity to outside owing to high viscosity of the mixture and thus resulting in greatly inferior mechanical and physical characteristics of the composite structure thus formed.

### DISCLOSURE OF INVENTION

### Technical Problem

Accordingly, the present invention has its primary purpose to solve such problems as described above and furthermore can provide an easy way to manufacture various types of composites which have excellent mechanical and physical characteristics.

### Technical Solution

In order to achieve the above objectives, this invention consists of several steps such as putting the main material i.e, solid particles of fillers in a mould, putting the subsidiary material i.e., fluid hardeners in a mould, mixing fillers and hardeners by maintaining them at a vacuum state for the required time, and the consummation of a composite by hardening the mixture.

### Advantageous Effects

This invention relates to a method for manufacturing a composite structure that is used in the fabrication of architectural, civil and mechanical facilities, by adopting a hardening process for filler (A) and fluid hardener (B) in a mould (10), where mechanical and physical properties are improved when the particle state of filler (A), the primary material, and the fluid state of hardener (B), the subsidiary material, are densely combined, without pores in the mould (10), in a vacuum state maintained for required time, and thanks to excellent workability secured in the process, various kinds of composite structures can be manufactured with ease in a large scale of production at a lower costs.

### BRIEF DESCRIPTION OF THE DRAWINGS

FIG. 1 to FIG. 5 are illustrations of the 1st “exercise example” to explain a composite structure according to the present invention.

FIG. 6 to FIG. 10 are illustrations of the 2nd “exercise example” to explain a composite structure according to the present invention.

FIG. 11 to FIG. 15 are illustrations of the 3rd “exercise example” to explain a composite structure according to the present invention.

FIG. 16 to FIG. 18 are illustrations to explain the examples of application of a composite structure according to the present invention.

### BEST MODE FOR CARRYING OUT THE INVENTION

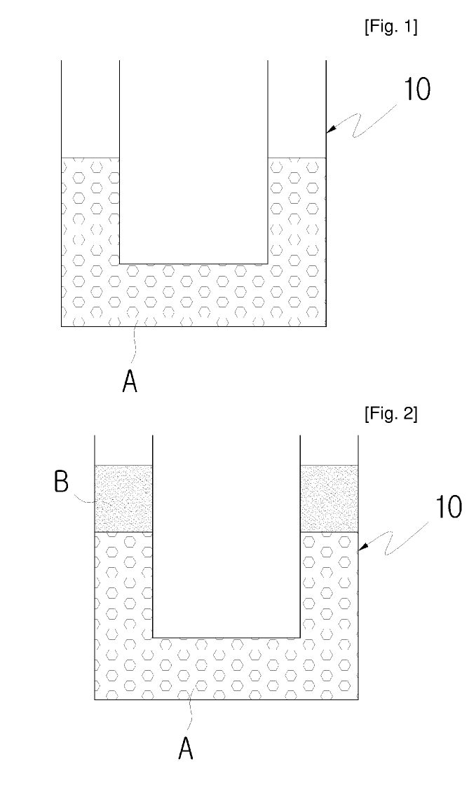

Following steps provide explanation of the 1st “exercise example” of the method of manufacturing a composite structure in accordance with the present invention in the order of each process with reference to FIG. 1 through FIG. 5.

Step 1. Put fillers, in solid particle state, into a mould (10) (refer to FIG. 1).

The fillers A in the state of solid particles are evenly distributed throughout the mould (10)despite complexity of the mould (10) and narrow spaces thereof owing to dimensions of the mould (10) itself.

Size and quality of fillers (A) can be properly decided at a users discretion based on given requirements. In this “exercise example”, the fillers (A) used are Granite.

Step 2. Put fluid hardener (B), the subsidiary material, into the mould (10) (refer to FIG. 2).

All kinds of materials known in the related art that can be hardened to a solid state through a chemical and/or physical reaction from a liquid state such as liquid, sol or slurry are acceptable fluid hardeners (B) for use in the present invention. The fluid fillers (B) used in this case of “exercise example” are epoxy resins added with a curing agent.

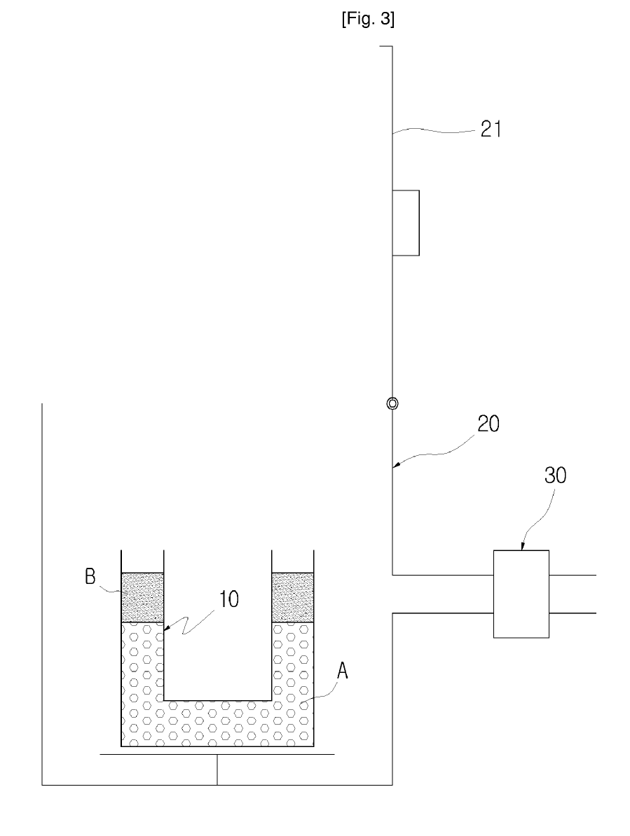

Step 3. Put the mould (10) charged with the fillers (A) and the fluid hardener (B) into the vacuum chamber (20) (refer to FIG. 3).

Step 4. Mix the fillers (A) and the fluid hardener (B) by maintaining a vacuum state for a required time in the vacuum chamber (20) (refer to FIG. 4).

Vacuum pressure is formed in the vacuum chamber (20) whereby the vacuum pump (30) is operated to maintain a constant degree of a vacuum in the vacuum chamber (20).

Under the vacuum pressure as described above, the fluid hardener (B) can satisfactorily permeate into regions between particles of fillers (A) despite high viscosity of fluid hardener (B) and narrow regions between fillers.

To make the fluid hardener (B) quickly permeate into the regions between particles of fillers (A) it is preferable to form appropriate vent holes for exhausting air in the mould (10). Location, size and no. of vent holes can be properly adjusted depending upon types and shapes of a composite, type and size of the fillers (A) and characteristics of the fluid hardener (B).

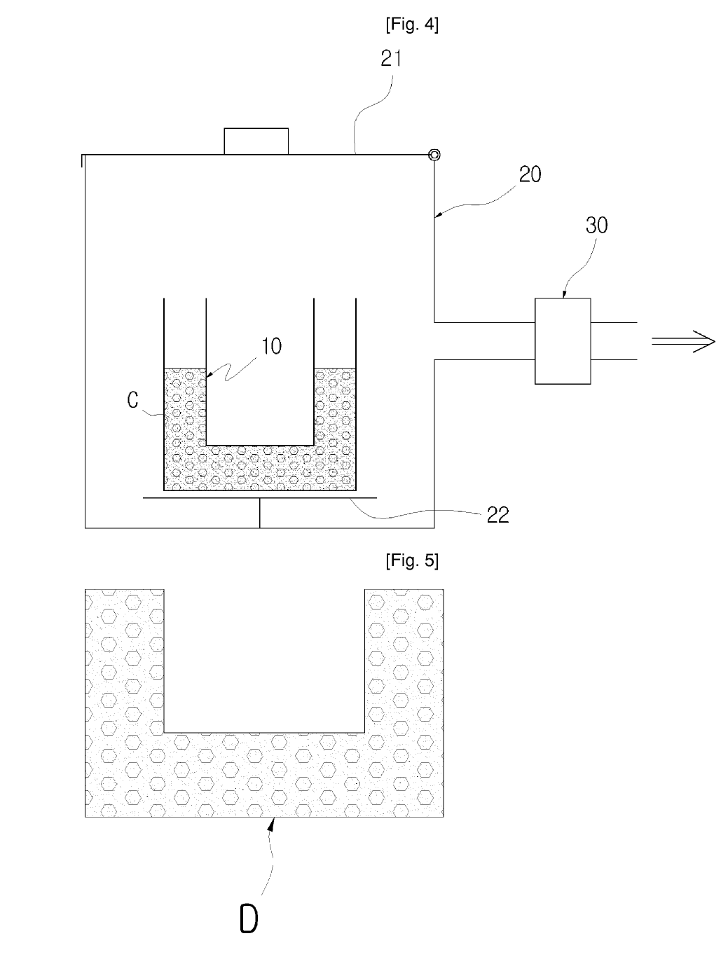

Step 5. Complete a composite structure (D) by hardening the fluid hardener (B) which makes part of the mixture (C) (refer to FIG. 5).

Once fillers (A) and hardener (B) are evenly mixed, the mixture (D) can be naturally hardened either in the vacuum chamber (20) while the mould (10) charged with the mixture (C) is left for a required time (here, inside of the vacuum chamber does not need to be in a vacuum state) or in air for a required time after the mould (10) is taken out of the vacuum chamber (20).

At a time when the composite structure (D)) is used, the composite structure (D) can be used without being separated from the mould (10), if necessary. From the 1st “exercise example”, a composite structure of epoxy-granite (D) was produced where, weight ratio of epoxy resin to granite was 10:1 and density of charging was over 90%.

As the fillers (A) and the hardener (B), in accordance with a preferred embodiment of the present invention, are mixed in the mould (10) in a vacuum state for the required time there is no need to apply external force to push the mixture (C) in order to charge the mixture (C) tightly into moulds (10) or to perform a forced mixing of the fillers (A) and the hardener (B) physically by use of a stirrer as adopted in the conventional way of mixing.

Furthermore, a composite structure formed in accordance with the above described embodiment of the present invention has good moulding workability allowing for greater ease in making various types of composites and therefore enables them to be more widely used in many fields of application with greatly improved mechanical and physical characteristics due to an absence of pores in the mixture thanks to the compact bonding of the fillers (A) and the fluid hardener (B).

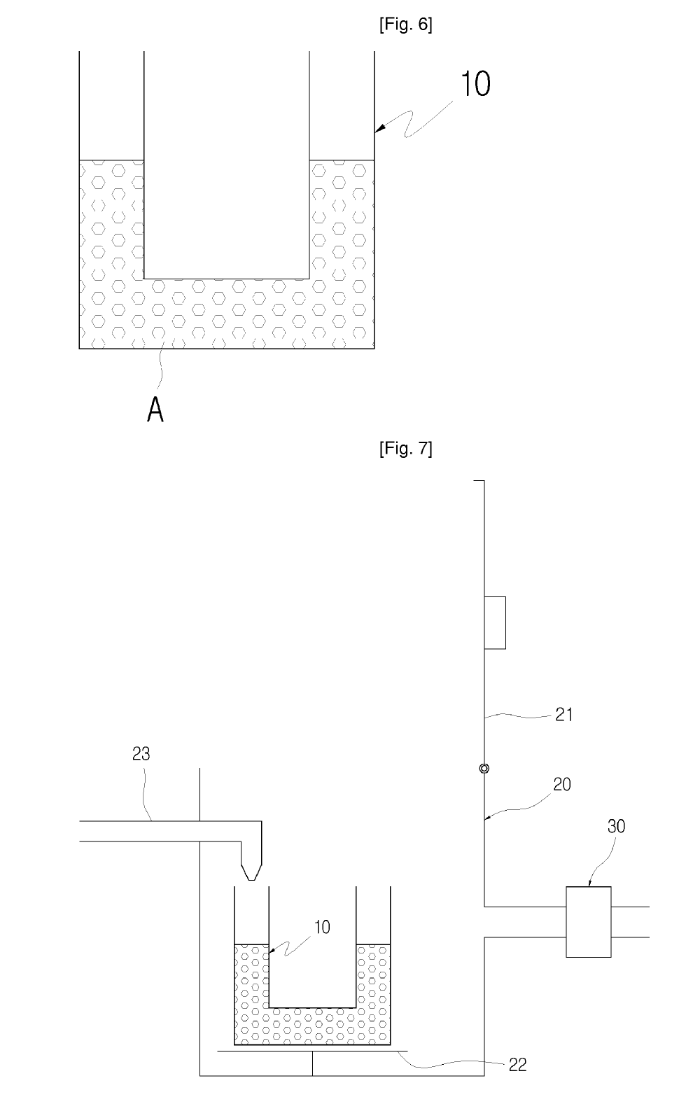

Following steps provide explanation of the 2nd “exercise example” of the method of manufacturing a composite structure in accordance with the present invention in the order of each process with reference to FIG. 6 through FIG. 10.

Step 1. Put fillers (A), the primary material in a solid particle state, into a mould (10) (refer to FIG. 6).

Step 2. Put a mould (10) charged with the fillers (A) into a vacuum chamber (20) (refer to FIG. 7).

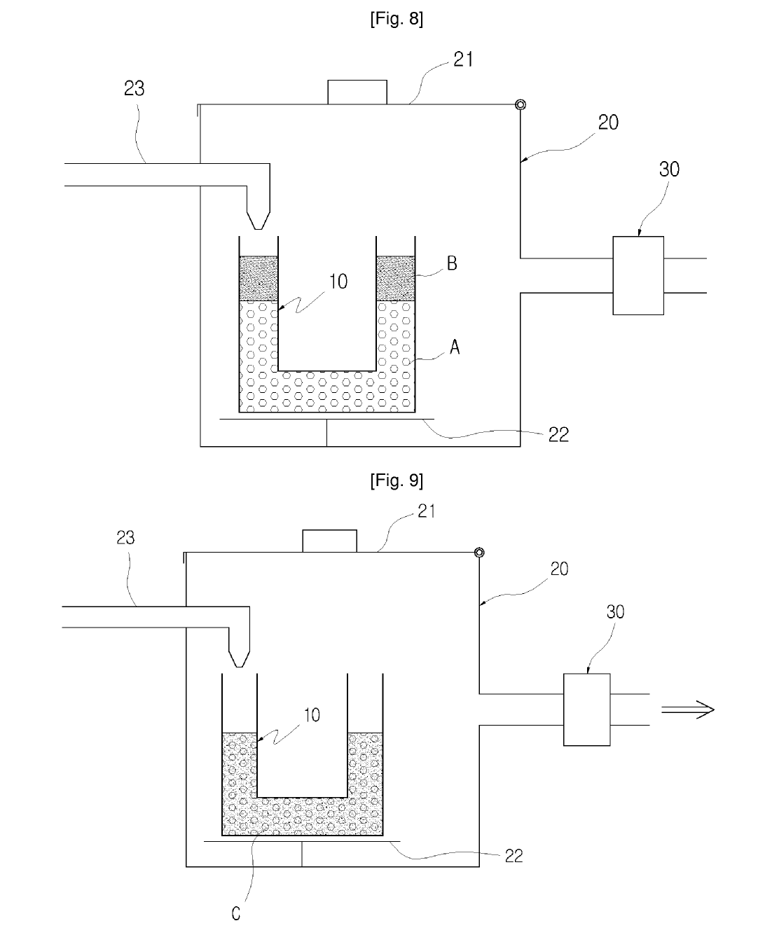

Step 3. Put a fluid hardener (B), the subsidiary material, into the mould (10) (refer to FIG. 8).

The fluid hardener (B) is put into the mould (10) in a vacuum chamber (20) through a supply unit (23) attached in the vacuum chamber (20).

The supply unit (23) for a fluid hardener (B) can control the volume of hardeners by opening/closing the supply line manually or automatically and any known device to handle this function can be adopted.

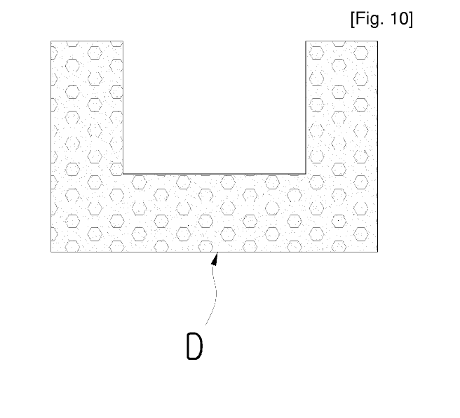

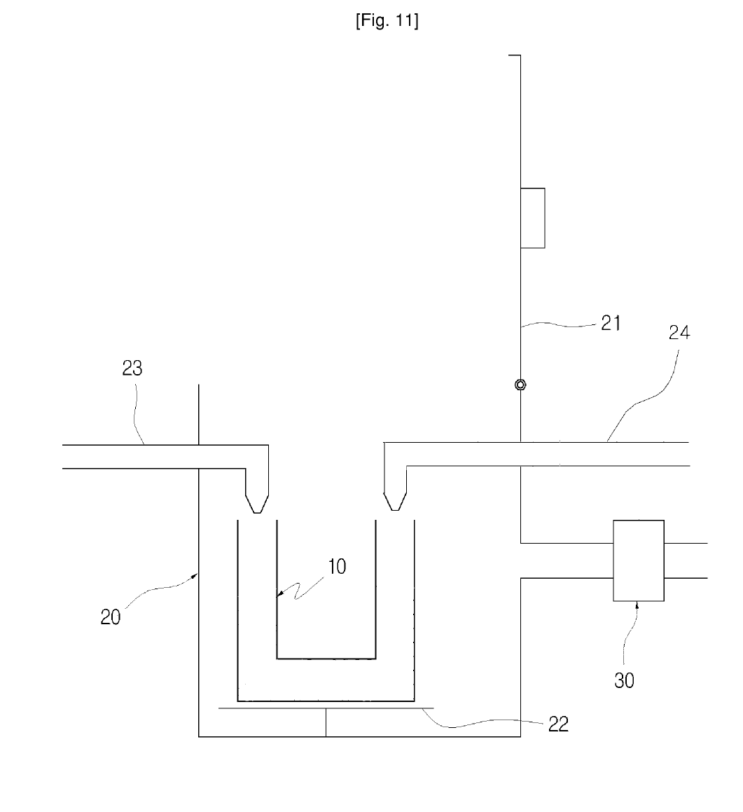

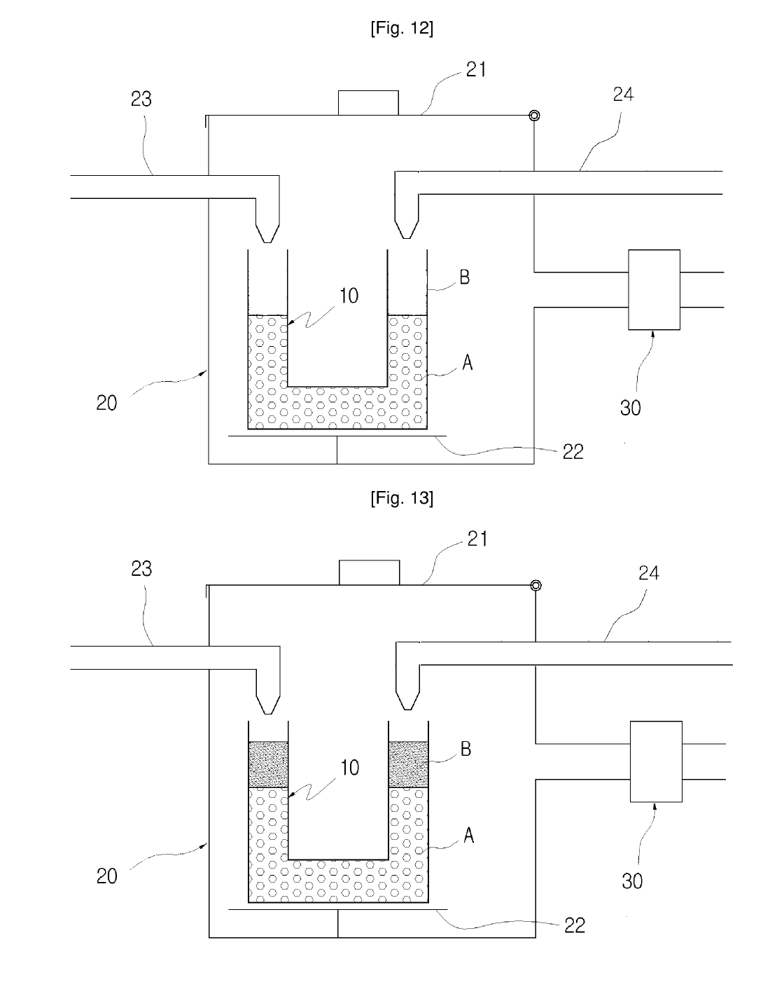

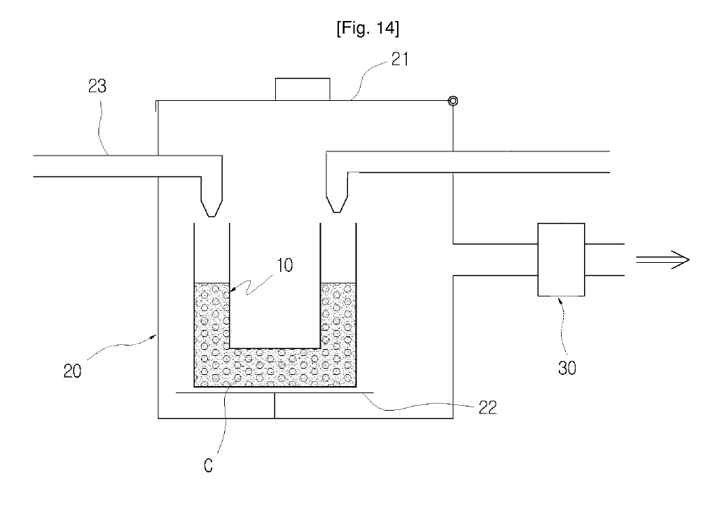

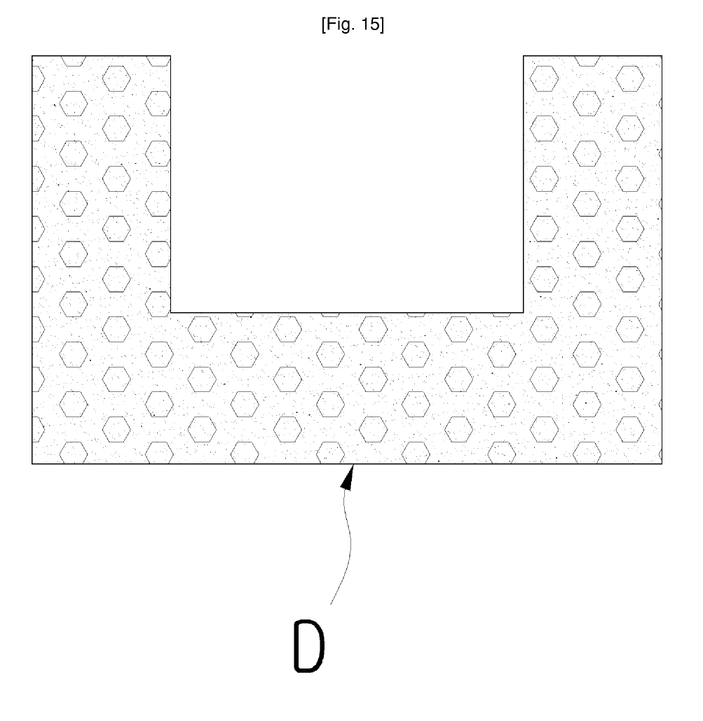

Step 4. Mix the fillers (A) and the fluid hardener (B) by maintaining a vacuum state for a required time in the vacuum chamber (20) (refer to FIG. 9).

Step 5. Complete a composite structure (D) by hardening a mixture (C)

(refer to FIG. 10).

Unlike the 1st and 2nd “exercise example”, the 3rd “exercise example” adopts a method of putting fillers (A) and the fluid hardener (B) into a mould (10) in the vacuum chamber (20) after the mould (10) is put, in advance, into the vacuum chamber (20).

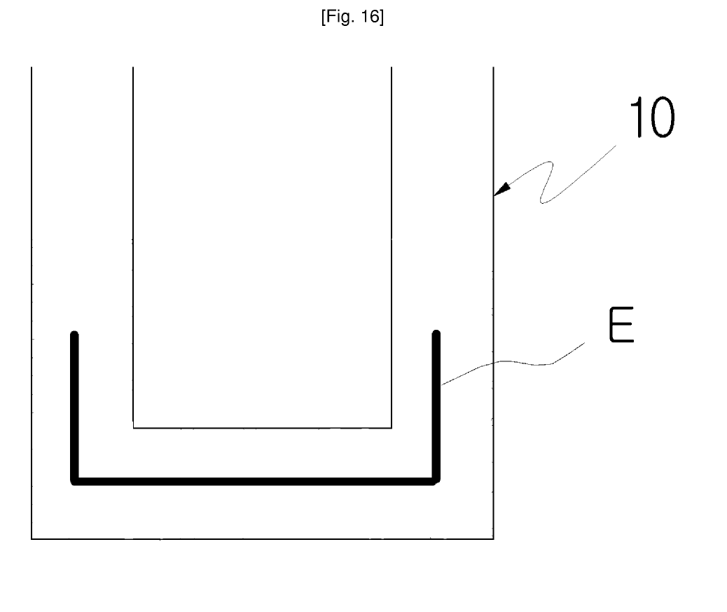

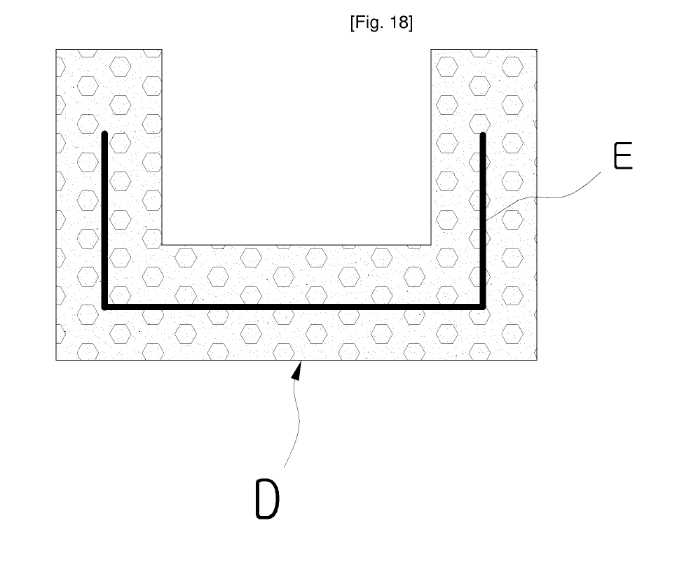

On the other hand, the method of manufacturing a composite structure with reinforcing frames (E) in accordance with the present invention is described as following with reference to FIG. 16 and FIG. 18.

First of all, reinforcing frames (E) are installed in a mould (10) together with fixed elements (not illustrated) such as brackets or jigs as shown in FIG. 16.

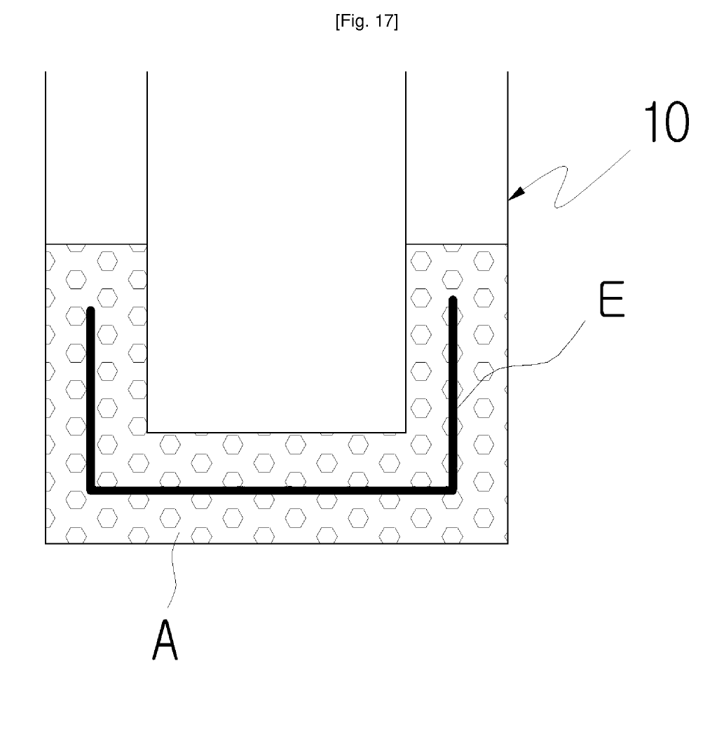

Then, fillers (A) in a solid state are put into a mould (10) so that reinforcing frames (E) can be embedded in the fillers A as illustrated in FIG. 17.

Soon after, a fluid hardener (B) is poured into the mould (10), the fillers (A) and the hardener (B) are mixed in a vacuum state in a vacuum chamber (20) for a required time, and finally a composite structure (D) is completed after hardening the mixture (C) as shown in FIG. 18.

Installation of reinforcing frames (E) in the moulds (10) as described above is conducted before the 1st step in case of the 1st and 2nd “exercise example”, or before the 1st step or between the 1st and 2nd step in case of the 3rd “exercise example”.

As seen in above “exercise example”, reinforcing frames (E) that are strengthened provide a great improvement in the strength of a composite structure (D), where good quality metal was applied as reinforcing frames (E) therefor.

However, these examples are given for the purpose of illustration and are not to be construed as limiting the scope of the invention, it would be appreciated by those skilled in the art that changes may be made without departing from the principles and spirit of the invention, the scope of which is defined in the claims and their equivalents.

Needless to say, for example, such works as moving the above mentioned moulds (10) to a vacuum chamber (20), putting the moulds (10) into the vacuum chamber (20) or taking them out and removing the moulds (10) taken from the vacuum chamber (20) to a specific location will be automatically performed by means of commonly known carriers (conveyer, hoist or transport tools such as robot arms).

1. A method to manufacture a composite structure as per the following steps;
step to put solid state of primary material into a form;
step to put fluid state of hardener into the form;
step to mix solid primary material and fluid hardener while maintaining a mould, where fillers and the hardener are put together, in a vacuum state for a required time.
step to complete a composite structure by hardening mixed compound.

2. A method of manufacturing a composite with its feature, the consummation of a composite structure equipped with frames, following after putting fillers into moulds and installing basic structures in the mould as described in claim 1.
